(19) United States
(12) Patent Application Publication
(10) Pub. No.: US 2019/0325433 A1
(43) Pub. Date: Oct. 24, 2019

(54) Game Currency System

(71) Applicant: American Express Travel Related Services Company, Inc., New York, NY (US)

(72) Inventors: David W. Hirsch, Gilbert, AZ (US); Kanagavel Kannan, Phoenix, AZ (US); Satish T. Narayanan, Phoenix, AZ (US); Arun Kumar Kammali Kannacheri Parambil, Phoenix, AZ (US)

(73) Assignee: American Express Travel Related Services Company, Inc., New York, NY (US)

(21) Appl. No.: 15/961,701

(22) Filed: Apr. 24, 2018

(51) Int. Cl. G06Q 20/38; A63F 13/792; G06Q 20/36; G06Q 30/02

(52) U.S. Cl. CPC G06Q 20/381; G06Q 30/0209; G06Q 20/363; A63F 13/792

(57) ABSTRACT

The system may be configured to perform operations including determining a standard game point conversion rate between a first reward point value associated with a first reward point and a standard game point value associated with a standard game point, wherein the first reward point is redeemable with a first business and the standard game point is redeemable with a first game merchant; receiving a request from a consumer profile to exchange a first reward point amount for a first standard game point amount; retrieving the first reward point amount from the consumer profile; calculating the first standard game point amount equal to the first reward point amount based on the standard game point conversion rate; generating the first standard game point amount; associating the first standard game point amount with a game user profile; and/or storing the first standard game point amount in the game currency platform.

### FIELD

The present disclosure generally relates to a system for exchanging business rewards points associated with business merchants and game merchant points associated with game merchants.

### BACKGROUND

Many businesses offer units of value in the way of points (e.g., loyalty points or reward points), which a business may issue to a consumer or employee. These points may be redeemed for value in the form of cash, services, digital products, or tangible items. Game merchants (e.g., merchants offering digital gaming services such as video games) may offer game points redeemable for in-game purchases or the purchase of other games. The business reward points may have value associated with them, as determined by (and specific to) the associated business. Likewise, the game merchant points may have value associated with them, as determined by (and specific to) the game merchant. Because there is no technology-enabled platform for exchanging value across merchants' systems, however, points from businesses may have no value associated with the game merchants or their game products, and vice versa. Similarly, game points from one game merchant may have no value associated with another game merchant. Even further, game points from a first game of a game merchant may have no value associated with a second game associated with the same game merchant.

In the state of the art, there is no technology-enabled platform for exchanging value across game merchants' systems. Thus, there is a need to integrate game merchants' systems and provide a common technology-enabled platform and/or exchange system in which the latent value of points between businesses and game merchants; between different game merchants; and/or between different games may be exploited. Additionally, there is no technology-enabled exchange rate and/or common currency of points between businesses and game merchants; between different game merchants; and/or between different games.

### SUMMARY

A system, method, and article of manufacture (collectively, “the system”) are disclosed relating to exchanging merchant points and game points. In various embodiments, the system may be configured to perform operations including determining, by a processor, a standard game point conversion rate between a first reward point value associated with a first reward point and a standard game point value associated with a standard game point, wherein the first reward point is redeemable with a first business and the standard game point is redeemable with a first game merchant that is integrated with the game currency platform; receiving, by the processor, a request from a consumer profile to exchange a first reward point amount for a first standard game point amount, wherein the first reward point amount comprises the first reward point, and the first standard game point amount comprises the standard game point; retrieving, by the processor, the first reward point amount from the consumer profile; calculating, by the processor, the first standard game point amount equal to the first reward point amount based on the standard game point conversion rate; generating, by the processor, the first standard game point amount in response to the calculating the first standard game point amount; associating, by the processor, the first standard game point amount with a game user profile comprised in the game currency platform associated with the consumer profile; and/or storing, by the processor, the first standard game point amount in the game currency platform.

In various embodiments, the method further comprises receiving, by the processor, a transaction request for a transaction to exchange a purchase standard game point amount for an item from the first game merchant; debiting, by the processor, the purchase standard game point amount from the first standard game point amount; and/or transmitting, by the processor, the purchase standard game point amount to the first game merchant. In various embodiments, the method further comprises identifying, by the processor, a transaction type of the item, in response to the receiving the transaction request, wherein the transaction request comprises transaction information associated with the item, and wherein the transaction information comprises a marker indicating the transaction type; and approving, by the processor, the transaction in response to the transaction type being game-related, wherein the debiting the purchase standard game point amount is in response to the approving the transaction.

In various embodiments, the method further comprises receiving, by the processor, a request from the game user profile to exchange an exchange standard game point amount for a desired first game merchant point amount comprising a first game merchant point associated with the first game merchant, wherein the exchange standard game point amount is a portion of the first standard game point amount; determining, by the processor, a second standard conversion rate between the standard game point value and a first game merchant point value associated with the first game merchant point; calculating, by the processor, the exchange standard game point amount equal to the desired first game merchant point amount based the second standard game point conversion rate; and/or transmitting, by the processor, the exchange standard game point amount to the first game merchant.

In various embodiments, the method further comprises receiving, by the processor, a request to transfer a supplementary standard game point amount from the first standard game point amount to a supplementary game user profile associated with the game user profile; and/or transmitting, by the processor, the supplementary standard game point amount to the supplementary game user profile, wherein the supplementary game user profile may be utilized by a different user than a user associated with the game user profile.

In various embodiments, determining the first standard conversion rate may comprise analyzing, by the processor, at least one of a demand for the first reward point, the first reward point value relative to a cash value, a public rating of the first business, a public following, a tenure of the consumer profile, or transaction count associated with the consumer profile. In various embodiments, determining the second standard conversion rate may comprise analyzing, by the processor, at least one of a demand for the game merchant point, a first game merchant point value relative to a national currency value, a tenure of the consumer transacting with the first game merchant, or a game transaction count associated with the consumer.

In various embodiments, the method further comprises receiving, by the processor, a request from the game user profile to exchange a second game merchant point amount for a second exchange standard game point amount, wherein the second game merchant point amount comprises a second game merchant point associated with a second game merchant integrated with the game currency platform, wherein the second exchange standard game point amount comprises the standard game point; determining, by the processor, a third standard conversion rate between a second game merchant point value associated with second game merchant point and the standard game point value; calculating, by the processor, the second exchange standard game point amount equal to the second game merchant point amount based on the third standard conversion rate; generating, by the processor, the second exchange standard game point amount in response to calculating the second exchange standard game point amount; associating, by the processor, the second standard game point amount with the game user profile comprised in the game currency platform; and/or storing, by the processor, the second standard game point amount in the game currency platform.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 shows an exemplary game currency system, in accordance with various embodiments;

FIG. 2 shows a flowchart depicting an exemplary method for exchanging business points for standard game points, in accordance with various embodiments;

FIG. 3 shows a flowchart depicting an exemplary method for exchanging standard game points for game merchant points, in accordance with various embodiments;

FIG. 4 shows a flowchart depicting an exemplary method for purchasing an item using standard game points, in accordance with various embodiments;

FIG. 5 shows a flow chart depicting an exemplary method for providing standard game points to a supplementary account, in accordance with various embodiments; and

FIG. 6 shows a flowchart depicting an exemplary method for scoring items, such as merchant offers, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

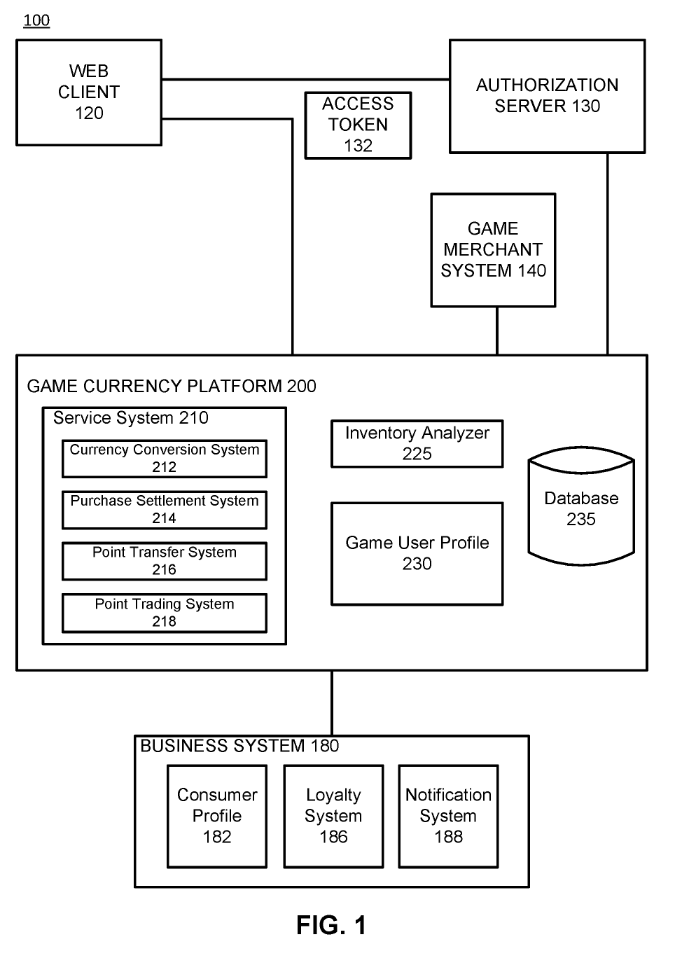

With reference to FIG. 1, in accordance with various embodiments, an exemplary game currency system 100 may comprise a web client 120, an authorization server 130, a game merchant system 140, a business system 180, and/or a game currency platform 200. In various embodiments, system 100 may comprise multiple game merchant systems 140 and/or multiple business systems 180. In various embodiments, any or all of the components of system 100 may be in electronic communication with one another.

In various embodiments, system 100, in operation, may have the capability to accept reward points associated with businesses and generate standard game points, which may be redeemable with game merchants. Therefore, system 100 may effectively generate standard game points in exchange for reward points. In various embodiments, system 100 may also exchange standard game points for reward points associated with businesses. Even further, system 100 may be capable of generating and providing standard game points in exchange for game merchant points (i.e., points awarded to game players for the games of game merchants), and/or exchanging standard game points for game merchant points. Additionally, in various embodiments, system 100 may facilitate the purchase of items (e.g., games or intra-game items from game merchant system 140, or other items from business system 180) using standard game points. System 100 may also allow a user to create a supplementary account and allocate standard game points (i.e., a supplementary game points amount) to the supplementary account. In various embodiments, only transactions involving game-related items may be approved for using standard game points to complete the transaction. The functions of system 100 may allow a user to allocate and utilize standard game points, as well as utilize reward points from businesses and game merchant points from game merchants (which otherwise may have gone unused) by converting them to standard game points. System 100 and/or game currency platform 200 may be computer-based, and may comprise a processor, a tangible non-transitory computer-readable memory, and/or a network interface. Instructions stored on the tangible non-transitory memory may allow system 100 to perform various functions, as described herein.

In various embodiments, web client 120 may incorporate hardware and/or software components. For example, web client 120 may comprise a server appliance running a suitable server operating system (e.g., MICROSOFT INTERNET INFORMATION SERVICES or, “IIS”). Web client 120 may be any device that allows a user to communicate with a network (e.g., a personal computer, personal digital assistant (e.g., IPHONE®, BLACKBERRY®), tablet, cellular phone, kiosk, and/or the like). Web client 120 may be in electronic communication with authorization server 130, game currency platform 200, and/or business system 180. Web client 120 may allow the consumer associated with consumer profile 182 and/or game user profile 230 to interact with game currency platform 200 and/or participate in transactions using standard game points.

Web client 120 includes any device (e.g., personal computer, mobile device, etc.) which communicates via any network, for example such as those discussed herein. In various embodiments, web client 120 may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with a server via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, browser may be configured to display an electronic channel.

In various embodiments, authorization server 130 may incorporate hardware and/or software components. Authorization server 130 may comprise a server appliance running a suitable server operating system (e.g., MICROSOFT INTERNET INFORMATION SERVICES or, “IIS”) and having database software (e.g., ORACLE) installed thereon. In various embodiments, authorization server 130 may be in electronic communication with web client 120, game currency platform 200 and/or business system 180, and/or any of the components comprised therein. In various embodiments, authorization server 130 may be comprised in business system 180 and/or game currency platform 200. Authorization server 130 may be configured to analyze the login information of a user accessing consumer profile 182 of business system 180 and/or game user profile 230 within game currency platform 200. In so doing, authorization server 130 may authenticate the user, and provide access token 132, which may be used to access business system 180 and/or game currency platform 200. In various embodiments, in response to a consumer initiating a transaction for an item through consumer profile 182 and/or game user profile 230, authorization server 130 may analyze the transaction information associated with the transaction. The transaction information may comprise a marker indicating a transaction type of the transaction (e.g., a purchase of food, beverage, clothing, games, or the like), and authorization server 130 may identify the transaction type by reading the marker. In response to the transaction type being associated with games (e.g., video games), authorization may approve use of standard game points as payment by the consumer to complete the transaction.

In various embodiments, game merchant system 140 may incorporate hardware and/or software components. Game merchant system 140 may comprise a server appliance running a suitable server operating system (e.g., MICROSOFT INTERNET INFORMATION SERVICES or, “IIS”) and having database software (e.g., ORACLE) installed thereon. In various embodiments, game merchant system 140 may be in electronic communication with game currency platform 200 and/or any of the components comprised therein. In various embodiments, each game merchant system 140 may be associated with a respective game merchant. System 100 may comprise multiple game merchant systems 140 in electronic communication and/or integrated with game currency platform 200 or any of the components comprised therein. Game merchant system 140 may comprise one or more games which a user may play, for example, by the user creating and playing through a game player profile specific to the user in game merchant system 140. Game merchant system 140 may generate and award players game merchant points, which may be redeemable with the game merchant for game purchases (e.g., purchase of in-game items or other games associated with the game merchant system 140). For example, a game player may earn, and game merchant system 140 may award, game merchant points in response to the player playing for a certain duration, completing various tasks within the game, purchasing game merchant points using cash, and/or the like. Game merchant points earned by a game player may be stored in game merchant system 140. In various embodiments, game merchant points may be redeemable only with the associated game merchant system 140 (which may include, for example, other games associated with game merchant system 140).

In various embodiments, business system 180 may incorporate hardware and/or software components. Business system 180 may comprise a server appliance running a suitable server operating system (e.g., MICROSOFT INTERNET INFORMATION SERVICES or, “IIS”) and having database software (e.g., ORACLE) installed thereon. In various embodiments, business system 180 may be in electronic communication with, web client 120, authorization server 130, and/or game currency platform 200 and any of the components comprised therein. In various embodiments, system 100 may comprise multiple business systems 180. Each business system 180 may be associated with a respective business (e.g., a merchant, transaction account issuer, or the like). In various embodiments, business system 180 may comprise a consumer profile 182, a loyalty system 186, and/or a notification system 188.

In various embodiments, consumer profile 182 may belong and/or be associated with a consumer, and may comprise any information or data about the consumer that describes an attribute associated with the consumer (e.g., a preference, an interest, demographic information, personally identifying information, and/or the like). Business system 180 may comprise multiple consumer profiles, each being associated with a consumer. In various embodiments, consumer profile 182 may be comprised in a separate system from business system 180. In various embodiments, consumer profile 182 may be based upon a variety of data. For example, consumer profile 182 may be based upon data that is received, culled, collected, and/or derived from a variety of sources, such as a consumer's transaction history, data associated with or available via a consumer's social networking profile (e.g., a consumer's FACEBOOK profile), web browsing data, data associated with a consumer's physical location, and/or other publicly and/or privately available sources of information about a consumer. In various embodiments, consumer profile 182 may not be based upon such data, unless a consumer opts in or requests that such data be used.

Further, in various embodiments, consumer profile 182 may be based upon data contributed by a consumer, a game merchant, a business, a third party, social media, apps and/or a service establishment (SE), as described herein. Such data may comprise, for example, a consumer's personal information, e.g., demographic information, a consumer's date of birth, a consumer's residence information, an address of the consumer's work, a specific preference associated with the consumer (e.g., a preference for a certain type of vacation, such as a preference for a tropical vacation), a website in which the consumer is interested, and/or the like. Further, a consumer may contribute data towards a consumer profile by way of a form and/or questionnaire, such as, for example, a web-based form or questionnaire.

In various embodiments, consumer profile 182 may comprise a transaction history associated with the consumer. The consumer's transaction history may comprise a history of the consumer's purchases from a game merchant(s), business(es), social media websites, apps, or the like, including information regarding product types, timing of purchases (e.g., a certain product types are purchased during summer, weekly grocery purchases, and/or the like), frequency of purchases, monetary amounts, geographic locations of purchases, frequency of purchases and quantity of using business reward points, products purchased using merchant points, or the like. Any reward points obtain for transacting with business system 180 or other entities may be stored in business system 180 and/or consumer profile 182.

In various embodiments, loyalty system 186 may generate and award consumers reward points associated with business system 180 such as, for example, for transacting with business system 180 and/or using business system's 180 products and/or services to complete transactions (e.g., when business system 180 is associated with a transaction account issuer, and the consumer utilizes transaction accounts issued by the issuer to complete transactions). Business system 180, for example, may issue reward points to consumer profile 182 via loyalty system 186 based on the number of transactions with or utilizing business system 180, the monetary amount of such transactions, the duration of the consumer profile 182 being established and used within business system 180, and/or the like.

In various embodiments, game currency platform 200 may be a platform to which one or more game merchant systems 140 may integrate using a defined application programming interface (API) interface that provides the ability to standardize the game merchant points and their associated value (from game merchant system 140) and the standard game point conversion rate for converting game merchant points to standard game points. Such integration may allow information and/or items (e.g., game merchant points and/or game-related products/items) to be transmitted between the game merchant systems 140 and game currency platform 200 and/or between games within a game merchant system 140 or between different game merchant systems 140. Similarly, one or more business systems 180 may integrate with game currency platform 200 using a defined API that provides the ability to standardize the reward points from loyalty system 186 and/or business system 180 to readable and consumable data in game currency platform 200. Such integration may allow information and/or items (e.g., reward points or products associated with the business systems 180) to be transmitted between the business systems 180 and game currency platform 200 and/or between business systems 180. Game currency platform 200, and/or any of the components comprised therein, may comprise a server appliance running a suitable server operating system (e.g., MICROSOFT INTERNET INFORMATION SERVICES or, “IIS”) and having database software (e.g., ORACLE) installed thereon. In various embodiments, game currency platform 200 may be configured to determine conversion rates between reward points from business systems 180 and a standard game point generated by game currency platform 200 (and their respective point values), and/or between game merchant points associated with various game merchant systems 140 and the standard game point (and their respective point values).

In various embodiments, to integrate with game merchant system 140 and/or business system 180, game merchants and/or businesses, respectively, may on-board or register with game currency platform 200. In order to facilitate an exchange of business reward points, and/or game merchant points, for standard game points (or vice versa), game currency platform 200 may be able to receive and/or retrieve reward points from consumer profile 182 and/or business system 180, and/or receive and/or retrieve game merchant points from game merchant system 140. To retrieve reward points, game currency platform 200 may link consumer profile 182 and/or business system 180 with game user profile 230 using a unique identifier associated with the consumer such as a web client identifier (i.e., device identifier) and/or consumer identifier. Similarly, to retrieve game merchant points, game currency platform 200 may link a game player profile in game merchant system 140 with game user profile 230 using a unique identifier associated with the consumer such as a web client identifier (i.e., device identifier) and/or consumer identifier. In various embodiments, the unique identifier associated with a consumer used to link business system 180 and/or consumer profile 182 with game currency platform 200 may be the same identifier used to link the consumer's game player profile in game merchant system 140 with game currency platform 200. Accordingly, the unique identifier associated with the consumer may be used to link and/or associate a consumer's consumer profile 182, game player profile in game merchant system 140, and/or game user profile 230. Business system 180 and/or game merchant system 140 may allow game currency platform 200 access to their reward points and/or game merchant points, respectively, via an API, for example, through which from game currency platform 200 may communicate with game merchant system 140 and business system 180 by using the unique identifier associated with the consumer to identify the consumer across the different systems. Similarly, consumers may register with game currency platform 200 and/or create a game user profile 230, and link their game user profile 230 to their consumer profile 182 and/or an associated game player profile within game merchant system 140 (for example, which may store game merchant points that the consumer has earned from game merchant system 140) by utilizing the unique identifier associated with the consumer.

To facilitate a point conversion as described herein, game currency platform 200 may utilize the login information for business system 180 and/or game merchant system 140 provided by the consumer (e.g., username, password, unique identifier, etc.) to access consumer profile 182 in business system 180 and retrieve/receive reward points, and/or to access a game player profile in game merchant system 140 and retrieve/receive game merchant points. Unique identifiers for each involved party in a point conversion or transaction may be transmitted to game currency platform 200 to authenticate the parties. In various embodiments, a unique identifier may identify more than one party in a transaction, such as two parties in a particular transaction involving a point conversion. Therefore, game currency platform 200 may be in electronic communication with consumer profile 182 and/or a game player profile in game merchant system 140 with electronic channels to transmit points, funds, and/or unique identifiers (via APIs, for example).

In various embodiments, game currency platform 200 may comprise a game user profile 230 associated with a (i.e., a consumer). Game currency platform 200 may comprise one or more game user profiles 230 for each game user. The game user may create game user profile 230 in order to access and utilize game currency platform 200. The game user profile 230 may be capable of storing the consumer's standard game points, presenting offers for exchanging points or purchasing items using standard game points, or the like.

In various embodiments, game currency platform 200 may comprise a service system 210 comprising microservices which perform the functions of service system 210 and/or game currency platform 200. The microservices comprised in service system 210 may be currency conversion system 212, purchase settlement system 214, point transfer system 216, and/or point trading system 218. In various embodiments, currency conversion system 212 may be configured to determine the conversion rate between the reward points from business system 180 and the standard game points, and/or between the standard game points and game merchant points. The standard game point may be a digital currency unassociated with any particular business or game merchant, but may be redeemable with any game merchant system 140 integrated with game currency platform 200, and/or may be exchanged for game merchant points associated with a game merchant system 140 integrated with game currency platform 200. Business systems 180 and/or game merchant systems 140 may recognize and accept the standard game points through their integration with game currency platform 200, and the defined API interface which presents standard game points to business systems 180 and/or game merchant systems 140 as consumable data. In various embodiments, the standard game point may be redeemable with any business system 180 integrated with game currency platform 200, and/or for reward points associated with a business system 180.

The standard game point conversion rate may reflect the relative value between the reward points of a business system 180 and the standard game point (i.e., a reward point value relative to a standard game point value). Additionally, the standard game point conversion rates for various business systems 180 may indicate the value of the reward points from one business system 180 relative to the reward points from another business system 180. In various embodiments, the standard conversion rate between reward points associated with business system 180 and standard game points may be determined by currency conversion system 212 based on a number of factors. Business system 180, with which the reward points may be associated, may dictate a number of factors in determining the standard conversion rate between the reward points and standard game points. The standard conversion rate may be a function of these factors. For example, business system 180 may take into account the tenure of the consumer that is exchanging reward points for standard game points (i.e., how long the consumer has been transacting with business system 180), the transaction count for a consumer (e.g., number of transactions and/or the monetary amount for which the consumer has used business system 180), the transaction rate (i.e., the cost of performing the exchange of points), a desired profit rate (i.e., an amount of reward points business system 180 may withhold as part of the price for the exchange), or the like. Business system 180 may transmit instructions to game currency platform 200 and/or currency conversion system 212 to take such aspects into account when determining the standard conversion rate between its reward points and the standard game points.

In various embodiments, game currency platform 200 and/or currency conversion system 212 may receive and utilize other or additional factors to determine the standard game point conversion rate between reward points associated with business system 180 and the standard game point. Such factors may include, for example, the value of a business's reward points, such as demand for a business's reward points, business reward point value relative to a national currency value (i.e., cash), a business's market value (e.g., stock prices or the like), a public rating or public opinion of the business, a public following of the business, or the like. In various embodiments, each factor may be assigned a weight such that one factor may affect the standard conversion rate more than another factor. As an example, currency conversion system 212 may determine that reward points associated with business system 180 points may have a standard game point conversion rate of 100 reward points (i.e., one standard game point equals 100 reward points for the business system 180). In various embodiments, a standard game point conversion rate may be determined for the reward points associated with each business system 180, and/or a single standard game point conversion rate may be determined for the reward points associated with multiple business systems 180 integrated with game currency platform 200.

In various embodiments, the demand for a business's reward points may be determined by the number of transactions conducted by consumers with the business in which the consumers are rewarded points, the number of transactions conducted by consumers with the business in which the consumer redeems reward points, the number of reward points awarded issued, and/or the number of promotions involving business reward points offered by a business. For example, if currency conversion system 212 detects that a large number of consumers are conducting transactions with a first business system 180 (and using and/or receiving high numbers of reward points associated with business system 180), currency conversion system 212 may determine that the value of reward points associated with the first business system 180 should increase and/or be relatively high compared to other business's reward points (especially if there is a lower supply of reward points associated with a business system 180 than are demanded based on transaction trends). As another example, if a second business system 180 offers many promotions involving receiving additional or more reward points than usual, or special offers for redeeming items, currency conversion system 212 may determine that the value of the second business system 180 reward points should decrease and/or be relatively low compared to other business's reward points because the business system 180 may be trying to increase usage of its reward points. Therefore, a reward point from the second business system 180 may exchange for an amount of standard business points that is less than that received in exchange for a reward point from the first business system 180. Currency conversion system 212 may take into account the reward point values of various business systems 180 in order to determine standard game point conversion rates for each respective reward point.

In various embodiments, a business's reward point value relative to a national currency (i.e., cash) may be determined by various methods. A business may place a cash value per reward point, such as $0.01 per reward point in case the consumer wishes to redeem reward points for cash. In various embodiments, the business's reward point value relative to cash may be based on the amount of reward points required to purchase an item using the reward points. For example, if 5,000 reward points are required to purchase a television, with a manufacturer's suggested retail price (MSRP) of $500, then currency conversion system 212 may determine that one reward point associated with the respective business system 180 is worth $0.10. On the other hand, 1,000 reward points associated with a second business system 180 integrated with game currency platform 200 may be required to purchase the same television, and therefore, currency conversion system 212 may determine that one reward point associated with the second business system is worth $0.50. In various embodiments, currency conversion system 212 may determine a cash value for reward points based on comparing the number of reward points required to obtain an item for multiple items, to create an average for a reward point cash value. Similarly, to determine standard game point conversion rates for two different business systems, currency conversion system 212 may analyze the difference in the number of reward points required to purchase the multiple items that are available from all business systems being analyzed, to establish an average.

The public rating or public opinion of a business may be determined based on a number of factors. Game currency platform 200 and/or currency conversion system 212 may have access to social media networks (e.g., FACEBOOK®, FOURSQUARE®, TWITTER®, MYSPACE®, LINKEDIN®, and the like), and trends in such social media networks may indicate whether public opinion of a business is high or low (or rising or falling). In various embodiments, currency conversion system 212 may be able to track the number of times a business appears in news and media, and then determine if such publicity is positive or negative. Currency conversion system 212, likewise, may be capable of detecting aspects of news and media related to a business, such as topics reflecting positive and negative publicity (e.g., by scanning reactions to news and media postings looking for comments containing praise, criticism, disgust, or the like). For example, if an article of a business's corruption is being shared thousands of times on a social media network, currency conversion system 212 may determine that the value of the business's reward points should decrease. Public opinion of a business may also be determined by a business's stock prices, revenue, changes in sales (e.g., a dramatic decrease may indicate a boycott), acquisition of or mergers with other companies, or the like. The public following of a business may also be determined by information gathered from social media networks and/or news sources. For example, for business systems 180 having social media accounts, currency conversion system 212 may observe the number of social media users following the businesses' social media account, metadata tags (e.g., hashtags) belonging to a business used by consumers and the frequency of such use, which also may be utilized to determine business publicity (e.g., recognition, articles, awards, protests, etc.).

In various embodiments, game currency platform 200 may gather inputs for determining the standard game point conversion rate between reward points and standard game points by being in electronic communication with consumer profile 182 (e.g., to monitor frequency of transactions and point accumulation between consumers and businesses to determine demand and/or value of reward points), social media or news networks to monitor metatags or other indicators of public following or public opinion of a business, loyalty system 186 and/or notification system 188 (explained herein) to determine items offered for the redemption of reward points, the value of such reward points, promotions offered, number of reward points issued, market reports to receive stock prices, and/or the like. The standard game point conversion rate between reward points and standard game points rates may be updated periodically at any suitable time interval (e.g., daily, weekly, or the like) by currency conversion system 212.

In various embodiments, game currency platform 200 and/or currency conversion system 212 may be configured to determine a standard game point conversion rate between game merchant points issued to a game user (i.e., consumer) by game merchant system 140 and the standard game point. The standard game point conversion rates for various game merchant systems 140 may indicate the value of the game merchant points from one game merchant system 140 relative to the game merchant points from another game merchant system 140, or the relative value of game merchant points between specific games (whether associated with the same game merchant system 140 or not). In various embodiments, game merchant system 140, with which the game merchant points may be associated, may dictate a number of factors in determining the standard conversion rate between the game merchant points and standard game points. For example, game merchant system 140 may take into account the tenure of the game user that is exchanging game merchant points for standard game points (i.e., how long the consumer has been playing a game associated with game merchant system 140 and/or transacting with game merchant system 140), a game transaction count of the game user (i.e., the number of transactions or game merchant point amounts earned and/or used by the game user through game merchant system 140), the transaction rate (i.e., the cost of performing the exchange of points), a desired profit rate (i.e., an amount of reward points game merchant system 140 may withhold as part of the price for the exchange), or the like. Game merchant system 140 may transmit instructions to game currency platform 200 and/or currency conversion system 212 to take such aspects into account when determining the standard conversion rate between its game merchant points and the standard game points.

In various embodiments, currency conversion system 212 may receive and utilize other or additional factors to determine the standard conversion rate between the game merchant points associated with game merchant system 140 and the standard game point. For example, such factors may include the value of a game merchant's points, or any similar factor used and described in relation to determining the standard game point conversion rate between the reward points associated with business system 180 and the standard game points. The value of a game merchant's points may be determined by analyzing the demand for a game merchant's points (how many players play the game for which the game merchant points are issued, how readily and how many game merchant points are issued, in total and per game player), the game merchant point value relative to a national currency value (i.e., cash value), or the like. In various embodiments, each factor may be assigned a weight such that one factor may affect the standard conversion rate more than another factor. The game merchant point value relative to cash may be based on the amount of game merchant points required to purchase an in-game item, or another game. For example, to purchase another game associated with game merchant system 140, or an in-game item, it may cost $50 or 50,000 game merchant points. Accordingly, each game merchant point may have a cash value of $0.001. In various embodiments, currency conversion system 212 may determine a cash value for game merchant points based on comparing the number of game merchant points required to obtain an item for multiple items and/or across multiple game merchant systems 140, to create an average for a game merchant point cash value. In various embodiments, a standard game point conversion rate may be determined for game merchant points associated with each game merchant system 140 and/or each game offered by game merchant system 140. In various embodiments, a single standard game point conversion rate may be determined for game merchant points associated with multiple game merchant systems 140 integrated with game currency platform 200.

In various embodiments, game currency platform 200 may gather inputs for determining the standard game point conversion rate between game merchant points and standard game points by being in electronic communication with game merchant system 140, and any game player profile comprised within game merchant system 140 associated with a game player (e.g., to monitor frequency of transactions and point accumulation between game players and game merchants to determine demand and/or value of game merchant points), promotions offered, number of game merchant points issued, and/or the like. The standard game point conversion rate between reward points and standard game points rates may be updated periodically at any suitable time interval (e.g., daily, weekly, or the like) by currency conversion system 212.

In various embodiments, in response to a standard game point conversion rate being determined for converting between reward points and standard game points, and/or game merchant points and standard reward points, point trading system 218 may be configured to facilitate the exchanging of points. For example, a consumer may request to exchange an amount of reward points in consumer profile 182 for an equivalent amount of standard game points, and, in response, point trading system 218 may retrieve and/or receive the reward points from business system 180 and/or consumer profile 182. Point trading system 218 may also retrieve and/or receive a payment from business system 180 for accepting the reward points, which was liability for business system 180. Point trading system 218 may facilitate a similar process for exchanging game merchant points from game merchant system 140 for standard game points. In response to receiving the reward points, point trading system 218 may generate the equivalent number of standard game points based on the standard game point conversion rate between the reward points and the standard game points, and assign them to the appropriate game user profile 230. In various embodiments, standard game points may have been previously generated, and therefore, the preexisting standard game points may be assigned to the appropriate game user profile 230.

In various embodiments, point trading system 218 may also be configured to facilitate an exchange of standard game points for reward points from business system 180, and/or for game merchant points. In response to a request to exchange standard game points for reward points, point trading system 218 may retrieve the standard game points from database 235 and/or game user profile 230, apply the standard conversion rate determined for the respective reward points, and calculate the number of standard game points required to equal the desired number of reward points. In response, point trading system 218 may transmit the standard game points to business system 180, and/or information to business system 180 indicating the number of reward points for business system 180 to generate for and/or assign to the respective consumer profile 182. Similarly, in response to a request to exchange standard game points for game merchant points, point trading system 218 may retrieve the standard game points from database 235 and/or game user profile 230, apply the standard conversion rate determined for the respective game merchant points, and calculate the number of standard game points required to equal the desired number of game merchant points. In response, point trading system 218 may transmit the standard game points, or information to game merchant system 140 indicating the number of game merchant points for game merchant system 140 to generate for and/or assign to the respective consumer profile.

In various embodiments, point trading system 218 may be configured to allow a consumer to purchase standard game points using cash. For example, through consumer profile 182 and/or a game player profile in game merchant system 140, the consumer may transmit cash to game currency platform 200, and/or point trading system 218 may retrieve/receive the cash value. Applying a standard game point conversion rate between the standard game points and a cash value, point trading system 218 may generate an amount of standard game points based on the standard game point conversion rate between the standard game points and the cash value, and assign them to the appropriate game user profile 230.

In various embodiments, point transfer system 216 may be configured to transfer standard game points into an appropriate storage area within game currency platform 200. In response to standard game points being generated and/or assigned in response to a points conversion by point trading system 218, point transfer system 216 may transfer the standard game points to database 235 for storage. In various embodiments, the standard game points may be transferred and/or stored in database 235 and associated with the appropriate game user profile 230 (i.e., associated with the user who exchanged the reward points or game merchant points for standard game points). In various embodiments, the standard game points associated with a game user profile 230 may be stored within game user profile 230. Point transfer system 216 may also allow the transfer of standard game points between game user profiles 230 within game currency platform 200.

In various embodiments, a consumer associated with game user profile 230 may create supplementary accounts associated with or comprise in game user profile 230, for the crediting/storage and usage of standard game points. Point transfer system 216 may also facilitate the transferring of standard game points to a supplementary account from the associated game user profile 230. The supplementary account may be accessed and utilized by someone other than or in addition to the consumer associated with game user profile 230. For example, the consumer associated with game user profile 230 may have a child, for whom the parent creates a supplementary account, and transfers a supplementary standard game point amount of standard game points to the supplementary account. By so doing, the parent can make sure that any purchases made by the child are only related to games, because for a transaction using standard game points to be approved by authorization server 130, the transaction must be of the game transaction type, as discussed herein. If the child were to try to purchase something other than game-related items (for example, alcohol, clothes, etc.), authorization server 130 would identify the transaction type as a type other than game-related, and deny the transaction. Also, transferring standard game points to the supplementary account may regulate the amount of points or currency the allowed user of the supplementary account may spend.

In various embodiments, purchase settlement system 214 may be configured to facilitate the transfer of standard game points to purchase items, for example, from game merchant system 140 and/or business system 180. For example, to purchase an in-game item from a game merchant system 140, purchase settlement system 214 may receive information from game merchant system 140 indicating how many standard game points are required to purchase the item. In various embodiments, purchase settlement system 214 may receive information from game merchant system 140 indicating how many game merchant points are required to purchase the item, and in response, currency conversion system 212 may apply the standard game point conversion rate to determine the required amount of game merchant points. In response, purchase settlement system 214 may transmit the standard game points required to purchase the item to game merchant system 140, and receive/retrieve the item purchased from game merchant system 140. As another example, to purchase an item from a business system 180, purchase settlement system 214 may receive information from business system 180 indicating how many standard game points are required to purchase the item. In various embodiments, purchase settlement system 214 may receive information from business system 180 indicating how many reward points are required to purchase the item, and in response, currency conversion system 212 may apply the standard game point conversion rate to determine the required amount of reward points. Purchase settlement system 214 may transmit the standard game points required to purchase the item to business system 180, and receive/retrieve the item purchased, or an item receipt (e.g., if the item is a physical object) from business system 180.

In various embodiments, inventory analyzer 225 of game currency platform 200 may detect and track the number of transactions facilitated by game currency platform 200 involving standard game points, track the number of reward points from respective business systems 180 converted to standard game points and the number of standard game points stored and/or used by respective game user profiles 230, or the like. Tracking and analysis by inventory analyzer 225 may provide information for business purposes of game currency platform 200 and/or to provide information for the determination of standard game point conversion rates for various business systems 180 and game merchant systems 140.

System 100 may allow a consumer to convert accumulated reward points associated with a business system 180, and/or game merchant points associated with a game merchant system 140, into standard game points generated by game currency platform 200. That way, if a consumer is not going to play a game anymore, or is reducing transactions with a business system 180, the consumer may convert the stored points in each to standard game points in order to maintain some value in points that otherwise would go unused. Additionally, game currency platform 200 and the standard game points allow a user to regulate the transactions allowed, because only game-related transactions may be approved by authorization server 130 in response to standard game points being used to complete the transaction. Further, consumers may obtain points from a business system 180 and/or game merchant system 140 by first exchanging their points from a different business system 180 and/or game merchant system 140 for standard game points, then exchanging the resulting standard game points for the desired reward points and/or game merchant points.

In various embodiments, business system 180 may comprise notification system 188 to present offers to a consumer associated with consumer profile 182. Notification system 188 may incorporate hardware and/or software components. For example, notification system 188 may comprise a server appliance running a suitable server operating system (e.g., MICROSOFT INTERNET INFORMATION SERVICES or, “IIS”). In various embodiments, notification system 188 may be a separate component of system 100, or comprised in game currency platform 200 and/or game merchant system 140.

In various embodiments, notification system 188 may comprise a scoring system. The scoring system may comprise hardware and/or software capable of scoring an item or determining a relative value to a consumer of reward points from one business system 180 to another (or one game merchant system 140 to another). In various embodiments, the scoring system may be in electronic communication with business system 180, consumer profile 182, game currency platform 200, and/or game merchant system 140. In various embodiments, the scoring system (comprising and implementing a collaborative scoring algorithm) may analyze the transaction history of consumer profile 182 and/or of a game player profile in game merchant system 140, and may use the analysis of the transaction history to determine a score for an item which may be offered or of interest to the consumer. To determine relevance to a consumer, the scoring system may look for a user's transaction habits in the respective transaction history, such as the types of transactions, the types of products or services transacted for, points used (i.e., the types and numbers of points), the locations of transactions, the times of the day, week, month, and/or year the transactions are made, and/or the like, and match that information with items the consumer or user may be interested in. The scoring system may have a weighted model configured to analyze the different aspects of the of consumer profile 182. For example, based on the consumer's transaction history, the scoring system may determine that a consumer may prefer business system 180 over game merchant system 140, or one business system or game merchant system over another. Therefore, the scoring system may score offers from the favored business system 180 or game merchant system 140 higher than other offers.

The score of an item may be a consumer relevance value (or “CRV”), which is the relevance of a particular item to the consumer. Stated another way, the CRV is a score of how likely the consumer or user will be interested in the item and take advantage of the item being presented to them. Moreover, in various embodiments, the scoring system may comprise a variety of “closed loop” or internal data associated with a consumer. In various embodiments, the scoring system may comprise a system for tailoring marketing. Additional information about CRVs and the associated offers may be found at U.S. patent application Ser. No. 13/794,374 filed on Mar. 11, 2013 and entitled “Systems and Methods for Tailoring Marketing”, which is incorporated by reference herein in its entirety.

In various embodiments, the scoring system may comprise a real time analysis system that may comprise hardware and/or software capable of adjusting the relevance of an item (e.g., a scored item) based upon a variety of criteria, such as one or more merchant criteria, one or more business rules, and/or the like. In various embodiments, the real time analysis system may be separate from, but in electronic communication with, and receive the variety of criteria from, scoring system. The real time analysis system may also be in electronic communication with, and receive information from, consumer profile 182 through the scoring system. For example, the real time analysis system may monitor real time information associated with a consumer or user such as changes in the time of year (i.e., holidays), time of day, consumer location, consumer preferences (e.g., the consumer has given the offer a “thumbs down,” or the consumer's transaction history data indicated a change in preferences), the consumers recent transaction history data, and/or the like. Based on any such changes, the real time analysis system may adjust the CRVs for consumers and items of potential interest to those consumers. In various embodiments, the real time analysis system may comprise a system, such as a system described in U.S. patent application Ser. No. 13/794,374, filed Mar. 11, 2013, and entitled “Systems and Methods for Tailoring Marketing.”

Based on the transaction history and CRV associated with various items or merchant points, the scoring system may recommend a transaction to a consumer by displaying an item on web client 120. For example, the item may comprise a suggestion to the consumer to exchange reward points from a business system 180 for standard game points based on factors such as the consumer's nonuse of the reward points, the consumer's frequent accumulation and/or use of the standard game points, or a bonus or beneficial exchange rate between the reward points and the standard game points. As another example, the item may comprise a suggestion to standard game points for a certain product based on the consumer's transaction history, which may include exchanging merchant points as a step in obtaining the product.

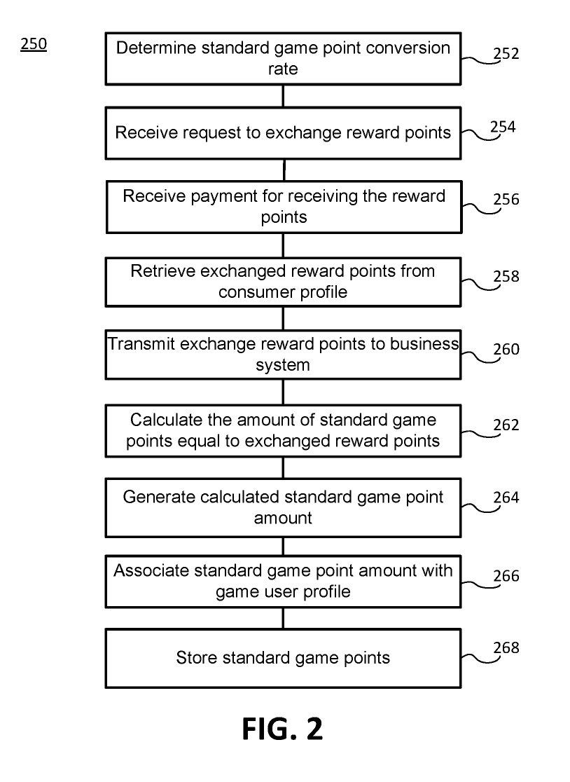

Referring now to FIGS. 2-6 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-6, but also to the various system components as described above with reference to FIG. 1.

With combined reference to FIGS. 1 and 2, in accordance various embodiments, a method 250 for exchanging business points for standard game points using system 100 is depicted. In various embodiments, game currency platform 200 and/or currency conversion system 212 may determine a standard game point conversion rate (step 252) between a reward point value of a reward point from a business system 180 and a standard game point value of a standard game point associated with game currency platform 200. To determine the standard game point conversion rate, game currency platform 200 may retrieve and/or receive information from various sources such as social media, news sources, stock exchanges, market information providers, business systems 180, consumer profiles (e.g., consumer profile 182), or any other suitable source.

As discussed herein, currency conversion system 212 may determine the standard game point conversion rate by analyzing various factors, including demand for the reward points form business system 180, reward point value relative to a national currency value (i.e., cash value), a public rating or public opinion of the business, a public following of the business, or the like. Greater demand for or usage of a business's reward points, the fewer reward points required to buy items, positive publicity and a good public opinion, and/or a large public following of a business may cause currency conversion system 212 to determine that a business system 180 having one or more of these characteristics should have greater value given to the associated reward points. On the other hand, little or no demand for or usage of a business's points, larger numbers of reward points required to purchase products, negative publicity or public opinion, and/or little or no public following may indicate to currency conversion system 212 that such a business's reward points should be valued less.

The valuation of reward points may be relative to another business system's reward points, such that the standard game point conversion rates between each of the businesses' reward points and the standard game point reflect the relative values of the businesses' reward points. For example, currency conversion system 212 may determine that a first business's reward points are more valuable than a second business's reward points. Therefore, a reward point from the first business system may purchase an amount of standard game points that is greater than the amount of standard game points purchased by a reward point from the second business system. Determining standard game point conversion rates between reward points associated with multiple business systems 180 and standard game points may allow a consumer to exchange reward points from multiple businesses in order to receive standard game points, which may be redeemable with more merchants or a desired merchant (e.g., a game merchant system 140). Conversion rates for reward points associated with each business system 180 may be stored in game currency platform 200 (e.g., in currency conversion system 212 and/or database 235).

In various embodiments, currency conversion system 212 may determine a standard game point conversion rate for each business system 180 and the associated reward points, that has integrated with game currency platform 200. Additionally, game currency platform 200 may receive and/or retrieve consumer information from any consumer registered with game currency platform 200 by accessing consumer profile 182 and transaction history stored therein, and/or any other information available within business system 180 and/or consumer profile 182.

In various embodiments, a consumer may register with game currency platform 200 by creating a game user profile 230 within game currency platform 200. The consumer may link or integrate the game user profile 230 with consumer profile 182, and/or with a game player profile associated with the consumer within a game merchant system 140. Such registration may allow the components of system 100 (i.e., game currency platform 200, game merchant system 140, and/or business system 180) to transmit information therebetween.

In various embodiments, with the integration and registration described above, the consumer may wish to obtain standard game points by exchanging reward points earned from business system 180. Therefore, the consumer may request an exchange of reward points for standard business points through consumer profile 182 via a user interface on web client 120. Game currency platform 200 may receive the request to exchange an amount of reward points (step 254) (i.e., a first reward point amount). To compensate game currency platform 200 for accepting the reward points from business system 180 (i.e., a liability), business system 180 may transmit payment to game currency platform 200. Game currency platform 200 may receive payment for receiving the reward points (step 256). In response to the consumer initiating a point exchange, game currency platform 200 may retrieve the first reward point amount from consumer profile 182 (step 258), where they may be stored in business system 180. In response to retrieving the first reward point amount from consumer profile 182, in various embodiments, game currency platform 200 may transmit the first reward point amount to business system 180 (step 260), in order to business system 180 to account for its settled liability. In various embodiments, the retrieved first reward point amount may not be transmitted to business system 180.

Game currency platform 200 and/or currency conversion system 212 may calculate the amount of standard game points (i.e., the first standard game point amount) that are equal to the first reward point amount (step 262) based on the conversion rate between the reward points and the standard game point. In various embodiments, in response to calculating the first standard game point amount, game currency platform 200 and/or point trading system 218 may generate the first standard game point amount (step 264) and associate them with the appropriate game user profile 230 (step 266), which the consumer may have created within game currency platform 200. In various embodiments, point trading system 218 may retrieve and associate preexisting standard game points with the appropriate game user profile 230 in response to calculating the first standard game point amount. The first standard game point amount may be stored (step 268) within game currency platform 200 within database 235, or within the game user profile 230 associated with the consumer.

It should be understood that method 250 may be completed for a second business system 180 wherein a consumer wishes to obtain standard game points by exchanging reward points associated with the second business system 180. A distinct standard game point conversion rate may be determined for the second business system 180, and reward points of the second business system 180 may be converted to standard game points based thereon. Additionally, in various embodiments, a method similar to method 250 may be applied to exchange standard game points for reward points associated with a business system 180, which may utilize the standard game point conversion rate determined by currency conversion system 212 in step 252. A consumer may also purchase standard game points using cash. In various embodiments, cash value may be uploaded to consumer profile 182, and then transmitted to game currency platform to be exchanged for standard game points. A standard game point conversion rate related to a cash value may be determined in order to complete the exchange. The standard game point conversion rate related to cash may be based on the value of standard game points (e.g., how many standard game points it takes to buy certain items).

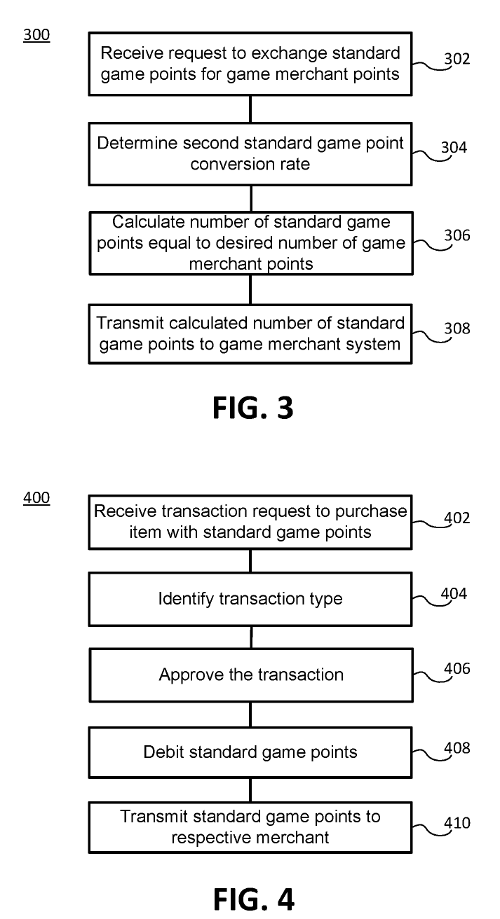

The standard game points a consumer has in game currency platform 200 may be used to obtain game merchant points associated with game merchant system 140 such that the consumer may purchase items associated with game merchant system 140 (e.g., games or in-game items). In accordance with various embodiments, and with combined reference to FIGS. 1 and 3, a method 300 for exchanging standard game points for game merchant points is depicted. A consumer may wish to apply her standard game points comprised in game currency platform 200 to a game merchant system 140 so the value of the standard game points may be used to purchase items associated with the game merchant system 140. Accordingly, in various embodiments, a consumer, via game user profile 230, may initiate a transaction to exchange standard business points for game merchant points associated with the game merchant system 140. Game currency platform 200 and/or game user profile 230 may receive the request to exchange standard game points for game merchant points (step 302).

In various embodiments, game currency platform 200 and/or currency conversion system 212 may determine a second standard game point conversion rate (step 304) for exchanging between game merchant points associated with game merchant system 140 and standard game points. As discussed herein, the second standard game point conversion rate may be based on a number of factors including the tenure of the game user that is exchanging game merchant points for standard game points (i.e., how long the consumer has been playing a game associated with game merchant system 140 and/or transacting with game merchant system 140), a game transaction count of the game user (i.e., the number of transactions or game merchant point amounts earned and/or used by the game user through game merchant system 140), the value of a game merchant's points, or any similar factor used and described in relation to determining the standard game point conversion rate between the reward points associated with business system 180 and the standard game points. The value of a game merchant's points may be determined by analyzing the demand for a game merchant's points (how many players play the game for which the game merchant points are issued, how readily and how many game merchant points are issued, in total and per game player), the game merchant point value relative to a national currency value (i.e., cash value), or the like.

Implementing the second standard game point conversion rate, game currency platform 200 and/or currency conversion system 212 may calculate the number of standard game points equal to a desired amount of game merchant points (step 306). In response, game currency platform 200 and/or point trading system 218 may transmit the calculated standard game point amount to game merchant system 140 (step 308), which may issue the desired game merchant points to the consumer in response.

In various embodiments, a method similar to methods 250 and 300 may be utilized to exchange game merchant points associated with game merchant system 140 for standard game points. The second standard game point conversion rate (determined in step 304 of method 300) would be utilized by currency conversion system 212 to determine the amount of standard game points equal to the game merchant point amount being exchanged. Point trading system 218 may retrieve the game merchant points from game merchant system 140 and generate and/or retrieve the equivalent amount of standard game points, and associate them with the appropriate game user profile 230.

In various embodiments, the standard game points a consumer has in game currency platform 200 may be used to purchase items from business system 180 and game merchant system 140. In accordance with various embodiments, and with combined reference to FIGS. 1 and 4, a method 400 for purchasing an item using standard game points is depicted. In various embodiments, a consumer having a game user profile 230 may initiate a transaction to purchase an item using the consumer's standard game points stored in game currency platform 200. The item may be an item from a merchant (e.g., business system 180), and/or a game merchant (e.g., game merchant system 140). The user may elect through game user profile 230 (which may be integrated with consumer profile 182 and/or a game player profile associated with the consumer in game merchant system 140) to use standard game points to pay for the item by logging into game user profile 230 and selecting an option to do so. In embodiments in which game user profile 230 is integrated with consumer profile 182 and/or a game player profile associated with the consumer in game merchant system 140, the option to use standard business points as payment may be presented in consumer profile 182 and/or the game player profile. Game currency platform 200 and/or purchase settlement system 214 may receive the transaction request to purchase an item with standard game points (step 402).

In various embodiment, the transaction request may comprise transaction information associated with the transaction (e.g., the item title, description, price, associated merchant, etc.), including a marker indicating the transaction type. Authorization server 130 and/or game currency platform 200 may identify the transaction type (step 404) as indicated by the marker. In response to the transaction type being game-related, authorization server 130 and/or game currency platform 200 may approve the transaction (step 406). In response to the transaction type not being game-related, authorization server 130 and/or game currency platform 200 may deny the transaction. Steps 404 and 406 may apply in embodiments in which game standard points may only be used as payment for game-related items. In various embodiments, game currency platform 200 and/or authorization server 130 may be configured to allow any or all desired types of transactions to utilize standard game points as payment.

In response to the transaction being approved by game currency platform 200 and/or authorization server 130, purchase settlement system 214 may debit the standard game points (step 408) required for the transaction from the total standard game points in consumer's game user profile 230, and transmit them to the respective merchant (step 410) (e.g., business system 180 and/or game merchant system 140).

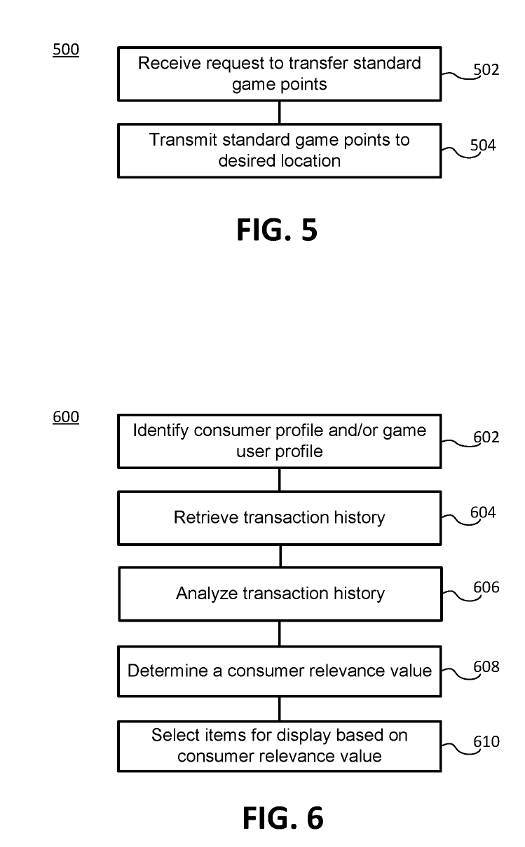

In various embodiments, game currency platform 200 may allow a consumer to create supplementary accounts associated with game user profile 230, which other users may use (e.g., a child of the consumer associated with game user profile 230). Supplementary accounts may be comprised within game user profile 230, but others may be given access to the supplementary accounts. In accordance with various embodiments, and with combined reference to FIGS. 1 and 5, a method 500 for providing standard game points to a supplementary account is depicted. The consumer may initiate a transfer of standard game points from game user profile 230 (as discussed herein, the standard game points may be stored in database 235). Game currency platform 200 and/or point transfer system 216 may receive a request to transfer standard game points (step 502) (i.e., a supplementary standard game point amount) to the desired location (e.g., another game user profile 230 or a supplementary account). In response, point transfer system 216 may transfer the standard game points to the desired location (step 504). The creation of a supplementary account may allow the consumer associated with the game user profile 230 to regulate what the user of the supplementary account may purchase (e.g., game-related purchases may only be completed with standard game points), and/or how many points (i.e., currency) the user of the supplementary account may spend.

In various embodiments, system 100 may offer items (e.g., point redemption and/or exchange suggestions) to the consumers having game user profiles 230 based on the consumers' transaction history, including spending and point-usage habits, or the like. FIG. 6 depicts a method 600 for scoring items (e.g., point exchanges) for consumers using system 100. With combined reference to FIGS. 1 and 6, the scoring system in notification system 188 may identify a consumer profile 182 and/or game user profile 230 (step 602) associated with a consumer. As discussed herein, in various embodiments, in order to use system 100, the consumer must have registered with and/or logged into system 100 and/or game currency platform 200 (e.g., created a game user profile 230, and/or provided login information for consumer profile 182 and/or a game player profile in game merchant system 140). As a result of the consumer logging in, game currency platform 200 may identify consumer profile 182 and/or game user profile 230 (step 602) associated with the consumer. In response to identifying consumer profile 182 and/or game user profile 230, the transaction history from consumer profile 182 and/or game user profile 230 may be retrieved (step 604). The scoring system, via a collaborative scoring algorithm, may analyze the transaction history (step 606), looking for trends in transaction and/or point exchanging habits, as discussed herein. Based on the analysis of the transaction history, the scoring system may determine a CRV (step 608) for at least one item (such as a product offered by a business system 180 and/or a game-related item offered by a game merchant system 140 in exchange for standard business points). The CRV may be reflective of the relevance of one item, or a plurality or list of items to a consumer profile.

In various embodiments, notification system 188 may receive the CRVs or lists of CRVs for the items. In various embodiments, notification system 188 may select items (e.g., offered point exchanges) for display, based on the CRVs (step 610), in consumer profile 182 and/or game user profile 230 via web client 120. For example, notification system 188 may preferentially select to only show items having a high CRV for a particular consumer. In various embodiments, the consumer may elect to only have notification system 188 show items in information boxes having high CRVs, or for preferred products and/or services (i.e., the items “recommended for you”). The consumer may select an offered item, and game currency platform 200, in response, may initiate the standard game points exchange associated with the item, as discussed herein.

The systems and processes discussed herein improve the functioning of the computer. For example, a consumer may exchange reward points and/or game merchant points for standard game points, and vice versa, thereby maximizing the value of the various points received by the consumer. Additionally, the game currency platform 200 providing a single location at which multiple game merchant systems 140 and/or business systems 180 may integrate, and through which information may be transmitted, allows much more efficient processing in exchanging, transferring, and redeeming points that serve as virtual currency for one or more entities (e.g., businesses, game merchants, or the like). By creating a standard game point, one currency may be redeemable with all game merchant systems 140 (or business systems 180) integrated with game currency platform 200. Furthermore, consumers utilizing game currency platform 200 via a game user profile 230 may transfer standard game points to other supplementary accounts, thereby regulating what the user of the supplementary account buys and how much is spent (e.g., only game-related products may be purchased with standard game points). Regarding maintenance of game currency system, the microservices in service system 210 provide discrete services and functions, and therefore, if something goes wrong, addressing the issue can be more efficient as the appropriate microservice may be easily identified and adjusted without affecting the other microservices.

The disclosure and claims do not describe only a particular outcome of exchanging digital currency (e.g., reward points, game merchant points, and/or standard game points), but the disclosure and claims include specific rules for exchanging digital currency that render information into a specific format that is then used and applied to create the desired results of exchanging digital currency, as set forth in McRO, Inc. v. Bandai Namco Games America Inc. (Fed. Cir. case number 15-1080, Sep. 13, 2016). In other words, the outcome of exchanging digital currency can be performed by many different types of rules and combinations of rules, and this disclosure includes various embodiments with specific rules. While the absence of complete preemption may not guarantee that a claim is eligible, the disclosure does not sufficiently preempt the field of exchanging digital currency at all. The disclosure acts to narrow, confine, and otherwise tie down the disclosure so as not to cover the general abstract idea of just exchanging digital currency. Significantly, other systems and methods exist for trading in digital points for other forms of redeemable points, so it would be inappropriate to assert that the claimed invention preempts the field or monopolizes the basic tools for exchanging digital currency. In other words, the disclosure will not prevent others from exchanging digital currency, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer (e.g., web client 120) is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information (e.g., standard game points available through game user profile 230) of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link (e.g., for an item recommended via scoring system and/or notification system 188) is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) standard game points and (ii) game currency platform 200, and/or a game user profile 230. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA system developed by AMAZON. Alexa is a cloud-based voice service that can help you with tasks, entertainment, general information and more. All Amazon Alexa devices, such as the Amazon Echo, Amazon Dot, Amazon Tap and Amazon Fire TV, have access to the Alexa Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The system may allow the user to access information about eligible accounts linked to an online account across all Alexa-enabled devices.

The consumer may be identified as a consumer of interest to a business based on the consumer's transaction history, which may including transactions at the business (e.g., using reward points associated with the business), types of transactions, type of transaction account, frequency of transactions, number of transactions, lack of transactions, timing of transactions, transaction history at other businesses, demographic information, personal information (e.g., gender, race, religion), social media or any other online information, potential for transacting with the merchant and/or any other factors.

The phrases consumer, customer, user, account holder, account affiliate, cardmember or the like shall include any person, entity, business, government organization, business, software, hardware, machine associated with a transaction account or profile having a digital currency (e.g., consumer profile 182, game user profile 230, and/or a game player profile in game merchant system 140), who buys items offered by one or more merchants (e.g., business system 180 and/or game merchant system 140) using the account or profile and/or who is legally designated for performing transactions on the account, regardless of whether a physical card is associated with the account. For example, the cardmember may include a transaction account owner, a transaction account user, an account affiliate, a child or supplementary account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. Record of Charge (ROC) data includes important information and enhanced data. For example, a ROC may contain details such as location, business name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, or a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER, JAVA Virtual Machine running on LINUX or WINDOWS).

Practitioners will appreciate that web client 120 may or may not be in direct contact with an application server. For example, web client 120 may access the services of an application server through another server and/or hardware component, which may have a direct or indirect connection to an Internet server. For example, web client 120 may communicate with an application server via a load balancer. In various embodiments, access is through a network or the Internet through a commercially-available web-browser software package.

As those skilled in the art will appreciate, web client 120 includes an operating system (e.g., WINDOWS® /CE/Mobile, OS2, UNIX®, LINUX®, SOLARIS®, MacOS, etc.) as well as various conventional support software and drivers typically associated with computers. Web client 120 may include any suitable personal computer, network computer, workstation, personal digital assistant, cellular phone, smart phone, minicomputer, mainframe or the like. Web client 120 can be in a home or business environment with access to a network. In various embodiments, access is through a network or the Internet through a commercially available web-browser software package. Web client 120 may implement security protocols such as Secure Sockets Layer (SSL) and Transport Layer Security (TLS). Web client 120 may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, or any other suitable database product. Moreover, the databases may be organized in any suitable manner, for example, as data tables or lookup tables. Each record may be a single file, a series of files, a linked series of data fields or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of web client 120 may be further equipped with an Internet browser connected to the Internet or an intranet using standard dial-up, cable, DSL or any other Internet protocol known in the art. Transactions originating at web client 120 may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a My SQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As used herein, the term “end user”, “consumer”, “customer”, “cardmember”, “business” or “merchant” may be used interchangeably with each other, and each shall mean any person, entity, government organization, business, machine, hardware, and/or software. A bank may also be referred to as a “business” or “merchant,” and may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant or business computer and a bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to a “party” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a business may be a grocery store, a retail store, a travel agency, a service provider, an on-line merchant, credit provider (e.g., an issuer), or the like.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

What is claimed is:

1. A method comprising:
determining, by a processor, a standard game point conversion rate between a first reward point value associated with a first reward point and a standard game point value associated with a standard game point,
wherein the first reward point is redeemable with a first business and the standard game point is redeemable with a first game merchant, wherein the first game merchant is integrated with a game currency platform;
receiving, by the processor, a request from a consumer profile to exchange a first reward point amount for a first standard game point amount, wherein the first reward point amount comprises the first reward point, and the first standard game point amount comprises the standard game point;
retrieving, by the processor, the first reward point amount from the consumer profile;
calculating, by the processor, the first standard game point amount equal to the first reward point amount based on the standard game point conversion rate;
generating, by the processor, the first standard game point amount in response to the calculating the first standard game point amount;
associating, by the processor, the first standard game point amount with a game user profile comprised in the game currency platform associated with the consumer profile; and
storing, by the processor, the first standard game point amount in the game currency platform.

2. The method of claim 1, further comprising:
receiving, by the processor, a transaction request for a transaction to exchange a purchase standard game point amount for an item from the first game merchant;
debiting, by the processor, the purchase standard game point amount from the first standard game point amount; and
transmitting, by the processor, the purchase standard game point amount to the first game merchant.

3. The method of claim 2, further comprising:
identifying, by the processor, a transaction type of the item, in response to the receiving the transaction request, wherein the transaction request comprises transaction information associated with the item, and wherein the transaction information comprises a marker indicating the transaction type; and
approving, by the processor, the transaction in response to the transaction type being game-related, wherein the debiting the purchase standard game point amount is in response to the approving the transaction.

4. The method of claim 1, further comprising:
receiving, by the processor, a request from the game user profile to exchange an exchange standard game point amount for a desired first game merchant point amount comprising a first game merchant point associated with the first game merchant, wherein the exchange standard game point amount is a portion of the first standard game point amount;
determining, by the processor, a second standard conversion rate between the standard game point value and a first game merchant point value associated with the first game merchant point;
calculating, by the processor, the exchange standard game point amount equal to the desired first game merchant point amount based the second standard game point conversion rate; and
transmitting, by the processor, the exchange standard game point amount to the first game merchant.

5. The method of claim 1, further comprising:
receiving, by the processor, a request to transfer a supplementary standard game point amount from the first standard game point amount to a supplementary game user profile associated with the game user profile; and
transmitting, by the processor, the supplementary standard game point amount to the supplementary game user profile, wherein the supplementary game user profile may be utilized by a different user than a user associated with the game user profile.

6. The method of claim 1, wherein the determining the first standard conversion rate comprises analyzing, by the processor, at least one of a demand for the first reward point, the first reward point value relative to a cash value, a public rating of the first business, a public following, a tenure of the consumer profile, or transaction count associated with the consumer profile.

7. The method of claim 4, wherein the determining the second standard conversion rate comprises analyzing, by the processor, at least one of a demand for the game merchant point, a first game merchant point value relative to a national currency value, a tenure of the consumer transacting with the first game merchant, or a game transaction count associated with the consumer.

8. The method of claim 1, further comprising:
receiving, by the processor, a request from the game user profile to exchange a second game merchant point amount for a second exchange standard game point amount, wherein the second game merchant point amount comprises a second game merchant point associated with a second game merchant integrated with the game currency platform, wherein the second exchange standard game point amount comprises the standard game point;
determining, by the processor, a third standard conversion rate between a second game merchant point value associated with second game merchant point and the standard game point value;
calculating, by the processor, the second exchange standard game point amount equal to the second game merchant point amount based on the third standard conversion rate;
generating, by the processor, the second exchange standard game point amount in response to calculating the second exchange standard game point amount;
associating, by the processor, the second standard game point amount with the game user profile comprised in the game currency platform; and
storing, by the processor, the second standard game point amount in the game currency platform.

9. An article of manufacture including a non-transitory, tangible computer readable storage medium having instructions stored thereon that, in response to execution by a processor, cause the processor to perform operations comprising:
determining, by the processor, a standard game point conversion rate between a first reward point value associated with a first reward point and a standard game point value associated with a standard game point,
wherein the first reward point is redeemable with a first business and the standard game point is redeemable with a first game merchant, wherein the first game merchant is integrated with a game currency platform;
receiving, by the processor, a request from a consumer profile to exchange a first reward point amount for a first standard game point amount, wherein the first reward point amount comprises the first reward point, and the first standard game point amount comprises the standard game point;
retrieving, by the processor, the first reward point amount from the consumer profile;
calculating, by the processor, the first standard game point amount equal to the first reward point amount based on the standard game point conversion rate;
generating, by the processor, the first standard game point amount in response to the calculating the first standard game point amount;
associating, by the processor, the first standard game point amount with a game user profile comprised in the game currency platform associated with the consumer profile; and
storing, by the processor, the first standard game point amount in the game currency platform.

10. The article of claim 9, further comprising:
receiving, by the processor, a transaction request for a transaction to exchange a purchase standard game point amount for an item from the first game merchant;
debiting, by the processor, the purchase standard game point amount from the first standard game point amount; and
transmitting, by the processor, the purchase standard game point amount to the first game merchant.

11. The article of claim 10, further comprising:
identifying, by the processor, a transaction type of the item, in response to the receiving the transaction request, wherein the transaction request comprises transaction information associated with the item, and wherein the transaction information comprises a marker indicating the transaction type; and
approving, by the processor, the transaction in response to the transaction type being game-related, wherein the debiting the purchase standard game point amount is in response to the approving the transaction.

12. The article of claim 9, further comprising:
receiving, by the processor, a request from the game user profile to exchange an exchange standard game point amount for a desired first game merchant point amount comprising a first game merchant point associated with the first game merchant, wherein the exchange standard game point amount is a portion of the first standard game point amount;
determining, by the processor, a second standard conversion rate between the standard game point value and a first game merchant point value associated with the first game merchant point;
calculating, by the processor, the exchange standard game point amount equal to the desired first game merchant point amount based the second standard game point conversion rate; and
transmitting, by the processor, the exchange standard game point amount to the first game merchant.

13. The article of claim 9, further comprising:
receiving, by the processor, a request to transfer a supplementary standard game point amount from the first standard game point amount to a supplementary game user profile associated with the game user profile; and
transmitting, by the processor, the supplementary standard game point amount to the supplementary game user profile, wherein the supplementary game user profile may be utilized by a different user than a user associated with the game user profile.

14. The article of claim 9, wherein the determining the first standard conversion rate comprises analyzing, by the processor, at least one of a demand for the first reward point, the first reward point value relative to a cash value, a public rating of the first business, a public following, a tenure of the consumer profile, or transaction count associated with the consumer profile.

15. The article of claim 12, wherein the determining the second standard conversion rate comprises analyzing, by the processor, at least one of a demand for the game merchant point, a first game merchant point value relative to a national currency value, a tenure of the consumer transacting with the first game merchant, or a game transaction count associated with the consumer.

16. The article of claim 9, further comprising:
receiving, by the processor, a request from the game user profile to exchange a second game merchant point amount for a second exchange standard game point amount, wherein the second game merchant point amount comprises a second game merchant point associated with a second game merchant integrated with the game currency platform, wherein the second exchange standard game point amount comprises the standard game point;
determining, by the processor, a third standard conversion rate between a second game merchant point value associated with second game merchant point and the standard game point value;
calculating, by the processor, the second exchange standard game point amount equal to the second game merchant point amount based on the third standard conversion rate;
generating, by the processor, the second exchange standard game point amount in response to calculating the second exchange standard game point amount;
associating, by the processor, the second standard game point amount with the game user profile comprised in the game currency platform; and
storing, by the processor, the second standard game point amount in the game currency platform.

17. A system comprising:
a processor,
a tangible, non-transitory memory configured to communicate with the processor, and
the tangible, non-transitory memory having instructions stored thereon that, in response to execution by the processor, cause the processor to perform operations comprising:
determining, by the processor, a standard game point conversion rate between a first reward point value associated with a first reward point and a standard game point value associated with a standard game point,
wherein the first reward point is redeemable with a first business and the standard game point is redeemable with a first game merchant, wherein the first game merchant is integrated with a game currency platform;
receiving, by the processor, a request from a consumer profile to exchange a first reward point amount for a first standard game point amount, wherein the first reward point amount comprises the first reward point, and the first standard game point amount comprises the standard game point;
retrieving, by the processor, the first reward point amount from the consumer profile;
calculating, by the processor, the first standard game point amount equal to the first reward point amount based on the standard game point conversion rate;
generating, by the processor, the first standard game point amount in response to the calculating the first standard game point amount;
associating, by the processor, the first standard game point amount with a game user profile comprised in the game currency platform associated with the consumer profile; and
storing, by the processor, the first standard game point amount in the game currency platform.

18. The system of claim 17, further comprising:
receiving, by the processor, a transaction request for a transaction to exchange a purchase standard game point amount for an item from the first game merchant;
debiting, by the processor, the purchase standard game point amount from the first standard game point amount; and
transmitting, by the processor, the purchase standard game point amount to the first game merchant.

19. The article of claim 18, further comprising:
identifying, by the processor, a transaction type of the item, in response to the receiving the transaction request, wherein the transaction request comprises transaction information associated with the item, and wherein the transaction information comprises a marker indicating the transaction type; and
approving, by the processor, the transaction in response to the transaction type being game-related, wherein the debiting the purchase standard game point amount is in response to the approving the transaction.

20. The article of claim 17, further comprising:
receiving, by the processor, a request from the game user profile to exchange an exchange standard game point amount for a desired first game merchant point amount comprising a first game merchant point associated with the first game merchant, wherein the exchange standard game point amount is a portion of the first standard game point amount;
determining, by the processor, a second standard conversion rate between the standard game point value and a first game merchant point value associated with the first game merchant point;
calculating, by the processor, the exchange standard game point amount equal to the desired first game merchant point amount based the second standard game point conversion rate; and
transmitting, by the processor, the exchange standard game point amount to the first game merchant.
